(19) United States
(12) Patent Application Publication
(10) Pub. No.: US 2026/0237289 A1
(43) Pub. Date: Aug. 13, 2026

(54) METHODS AND IOT LARGE MODEL SYSTEMS FOR SMART CITY FALLING OBJECT EMERGENCY SUPERVISION

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Rui RU, Chengdu (CN); Yi ZHAO, Chengdu (CN)

(73) Assignee: CHENGDU QINCHUAN IOT TECHNOLOGY CO., LTD., Chengdu (CN)

(21) Appl. No.: 19/636,909

(22) Filed: Apr. 1, 2026

(30) Foreign Application Priority Data
Feb. 14, 2026 (CN) 202610215564.X

(51) Int. Cl. G08B 31/00; G01C 21/34; G01C 21/36; G06V 10/764; G06V 20/40; G06V 20/52; G08B 7/06; H04N 7/18; H04N 23/61; H04N 23/66

(52) U.S. Cl. CPC G08B 31/00; G01C 21/3415; G01C 21/3667; G06V 10/764; G06V 20/41; G06V 20/52; G08B 7/06; H04N 7/18; H04N 23/61; H04N 23/66

(57) ABSTRACT

A method and an IoT large model system for smart city falling object emergency supervision are provided. The method includes: obtaining a surveillance video stream including a building facade; identifying potential falling object(s) and corresponding risk feature label(s) according to the surveillance video stream; determining falling object risk level(s) of the potential falling object(s) according to the potential falling object(s) and the risk feature label(s); determining a regional risk level of each region in the building facade according to the falling object risk level(s); in response to determining that there is a risk area where the regional risk level is greater than a preset risk level, controlling a lighting device corresponding to the risk area to operate with a warning color; and determining early warning information according to the risk feature label(s), and controlling an early warning device corresponding to the risk area to issue the early warning information.

### CROSS-REFERENCE TO RELATED APPLICATIONS

This application claims priority to Chinese Patent Application No. 202610215564.X, filed on February 14, 2026, the contents of which are hereby incorporated by reference.

### TECHNICAL FIELD

The present disclosure relates to the field of smart city falling object supervision, and in particular to a method and an IoT large model system for smart city falling object emergency supervision for smart city falling object emergency supervision.

### BACKGROUND

Falling object events are an urgent urban safety issue that seriously endangers people's lives and property safety. Currently, identifying falling object risks and providing early warnings still face challenges. Supervision and early warning for falling objects still rely heavily on manual effort. The scope and intensity of supervision are also limited. Furthermore, real-time monitoring cannot be conducted to take timely preventive or early warning measures for potential falling object incidents. In addition, existing surveillance systems lack associated applications in the field of falling objects. These systems primarily rely on fixed cameras. Due to their limited shooting angles, it is difficult to comprehensively cover each region of a building.

Therefore, there is a need to provide a method for smart city falling object emergency supervision to more effectively and comprehensively identify falling object risks and provide early warnings.

### SUMMARY

One or more embodiments of the present disclosure provide a method for smart city falling object emergency supervision. The method is performed by a falling object emergency supervision management platform of an IoT large model system for smart city falling object emergency supervision, and includes: obtaining a surveillance video stream including a building facade; identifying at least one potential falling object and at least one risk feature label corresponding to the at least one potential falling object according to the surveillance video stream; determining at least one falling object risk level of the at least one potential falling object according to the at least one potential falling object and the at least one risk feature label; determining a regional risk level of each region in the building facade according to the at least one falling object risk level; in response to determining that there is a risk area where the regional risk level is greater than a preset risk level, controlling a lighting device corresponding to the risk area to operate with a warning color; and determining early warning information according to the at least one risk feature label, and controlling an early warning device corresponding to the risk area to issue the early warning information.

One or more embodiments of the present disclosure provide an IoT large model system for smart city falling object emergency supervision, comprising a falling object emergency supervision management platform, wherein the falling object emergency supervision management platform includes: an obtaining module, configured to obtain, through a falling object emergency supervision sensing network platform, a surveillance video stream including a building facade obtained by a falling object emergency supervision object platform; a recognition module, configured to identify at least one potential falling object and at least one risk feature label corresponding to the at least one potential falling object according to the surveillance video stream; a risk level determination module, configured to determine at least one falling object risk level of the at least one potential falling object according to the at least one potential falling object and the at least one risk feature label; a warning module, configured to: determine a regional risk level of each region in the building facade according to the at least one falling object risk level; in response to determining that there is a risk area where the regional risk level is greater than a preset risk level, send an instruction to the falling object emergency supervision object platform through the falling object emergency supervision sensing network platform to control a lighting device corresponding to the risk area to operate with a warning color; and determine early warning information according to the at least one risk feature label, send the early warning information to a falling object emergency supervision user platform through a falling object emergency supervision service platform, and/or send the early warning information to the falling object emergency supervision object platform through the falling object emergency supervision sensing network platform to control an early warning device corresponding to the risk area to issue the early warning information.

One or more embodiments of the present disclosure provide a non-transitory computer-readable storage medium storing computer instructions, wherein when a computer reads the computer instructions from the storage medium, the computer performs the method for smart city falling object emergency supervision.

### BRIEF DESCRIPTION OF THE DRAWINGS

The present disclosure is further described by way of exemplary embodiments, which are described in detail through the accompanying drawings. These embodiments are not limiting. In these embodiments, the same reference numerals denote the same structures, wherein:

FIG. 1 is a schematic diagram illustrating an exemplary platform structure of an IoT large model system for smart city falling object emergency supervision according to some embodiments of the present disclosure;

FIG. 2 is a flowchart illustrating an exemplary process for smart city falling object emergency supervision according to some embodiments of the present disclosure;

FIG. 3 is a schematic diagram of an exemplary process for determining a potential falling object and a risk feature label based on a model according to some embodiments of the present disclosure;

FIG. 4 is a schematic diagram of an exemplary process for determining a first classification confidence according to some embodiments of the present disclosure;

FIG. 5 is a schematic diagram of an exemplary process for determining a potential falling object and a risk feature label according to some embodiments of the present disclosure;

FIG. 6 is a schematic diagram of an exemplary process for determining a falling object risk level based on a model according to some embodiments of the present disclosure.

### DETAILED DESCRIPTION

To more clearly illustrate the technical solutions of the embodiments of the present disclosure, the drawings used in the description of the embodiments are briefly introduced below. Obviously, the drawings in the following description are merely some examples or embodiments of the present disclosure. For a person of ordinary skill in the art, without creative effort, the present disclosure may be applied to other similar scenarios based on these drawings. Unless obviously obtained from the context or the context illustrates otherwise, the same numeral in the drawings refers to the same structure or operation.

It should be understood that the terms "system," "device," "unit," and/or "module" used herein are methods for distinguishing components, elements, parts, sections, or assemblies of different levels. However, if other words may achieve the same purpose, the words may be replaced by other expressions.

As shown in the present disclosure and the claims, unless the context clearly indicates an exception, the terms "a," "an," "one," and/or "the" are not specifically singular and may also include plural. Generally, the terms "include" and "comprise" only indicate the inclusion of explicitly identified steps and elements. These steps and elements do not constitute an exclusive list. A method or device may also include other steps or elements.

Flowcharts are used in the present disclosure to illustrate operations performed by a system according to embodiments of the present disclosure. It should be understood that preceding or following operations are not necessarily performed precisely in order. Conversely, each step may be processed in reverse order or simultaneously. At the same time, other operations may be added to these processes, or one or more operations may be removed from these processes.

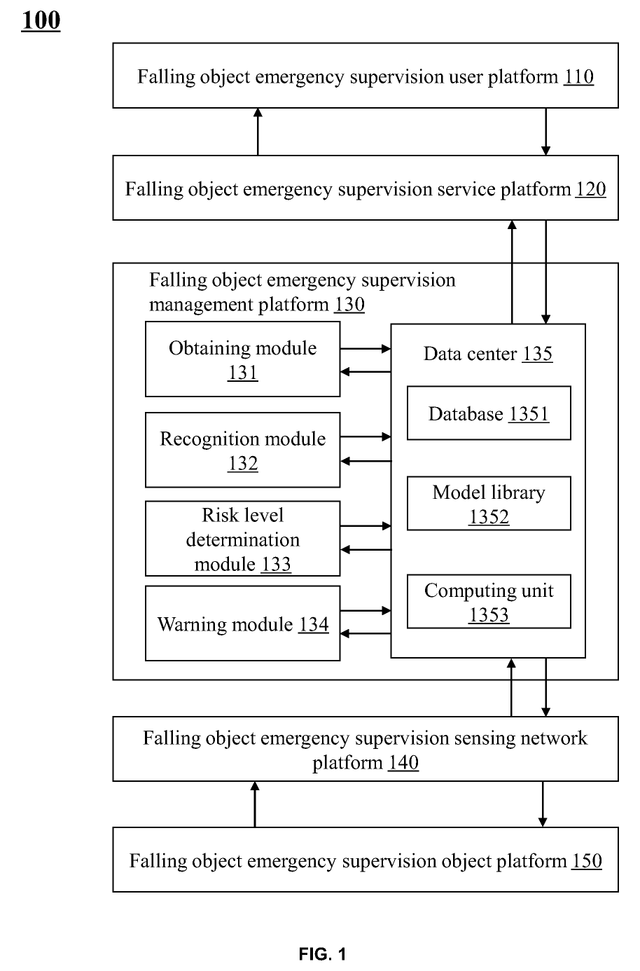

FIG. 1 is a schematic diagram illustrating an exemplary platform structure of an IoT large model system for smart city falling object emergency supervision according to some embodiments of the present disclosure.

The IoT large model system for smart city falling object emergency supervision refers to a system composed of an Internet of Things (IoT) model architecture that enables efficient operation of large amounts of data. In the system, various artificial intelligence models such as neural network models, machine learning models, and large language models may be integrated to assist in data perception and processing.

As shown in FIG. 1, an IoT large model system 100 for smart city falling object emergency supervision (hereinafter referred to as "system 100") includes a falling object emergency supervision user platform 110, a falling object emergency supervision service platform 120, a falling object emergency supervision management platform 130, a falling object emergency supervision sensing network platform 140, and a falling object emergency supervision object platform 150.

The falling object emergency supervision user platform 110 is a platform for information interaction with a user. For example, the falling object emergency supervision user platform 110 may be configured as a user terminal, including a mobile phone, a computer, a vehicle-mounted terminal, a monitoring terminal, etc. The user may be a superior emergency supervision department or a citizen.

In some embodiments, the falling object emergency supervision user platform 110 may perform data interaction with the falling object emergency supervision management platform 130 through the falling object emergency supervision service platform 120. For example, the falling object emergency supervision user platform 110 sends user requirements (e.g., monitoring requirements for falling objects, etc.) to the falling object emergency supervision management platform 130. As another example, the falling object emergency supervision user platform 110 obtains monitored falling object information and early warning information from the falling object emergency supervision management platform 130. The falling object emergency supervision user platform 110 may send the early warning information to the user through the user terminal.

The falling object emergency supervision service platform 120 is a platform for service communication and for processing and storing service data.

In some embodiments, the falling object emergency supervision service platform 120 may be configured as a single server or a group of servers. The server group may be centralized or distributed. For example, the server group may constitute a distributed system. In some embodiments, the server may be local or remote.

In some embodiments, the falling object emergency supervision service platform 120 may also be configured to include a database or storage device.

In some embodiments, the falling object emergency supervision service platform 120 may interact with the falling object emergency supervision user platform 110 and the falling object emergency supervision management platform 130 for data exchange.

The falling object emergency supervision management platform 130 is a platform for performing falling object emergency management. In some embodiments, the falling object emergency supervision management platform 130 is configured as a processor, such as a central processing unit, a microcontroller, an embedded processor (EP), a graphics processing unit (GPU), etc., or any combination thereof.

As shown in FIG. 1, the falling object emergency supervision management platform 130 may include an obtaining module 131, a recognition module 132, a risk level determination module 133, a warning module 134, and a data center 135. The obtaining module 131, the recognition module 132, the risk level determination module 133, and the warning module 134 are components/modules internally integrated with corresponding data processing instructions.

The obtaining module 131 obtaines, through the falling object emergency supervision sensing network platform 140, a surveillance video stream including a building facade obtained by the falling object emergency supervision object platform 150.

The recognition module 132 identifies at least one potential falling object and at least one corresponding risk feature label based on the surveillance video stream.

The risk level determination module 133 determines at least one falling object risk level of the at least one potential falling object based on the at least one potential falling object and the at least one risk feature label.

The warning module 134 configured to: determine a regional risk level of each region in the building facade according to the at least one falling object risk level; in response to determining that there is a risk area where the regional risk level is greater than a preset risk level, send an instruction to the falling object emergency supervision object platform 150 through the falling object emergency supervision sensing network platform 140 to control a lighting device corresponding to the risk area to operate with a warning color; and determine the early warning information according to the at least one risk feature label, send the early warning information to the falling object emergency supervision user platform 110 through the falling object emergency supervision service platform 120, and/or send the early warning information to the falling object emergency supervision object platform 150 through the falling object emergency supervision sensing network platform 140 to control an early warning device corresponding to the risk area to issue the early warning information.

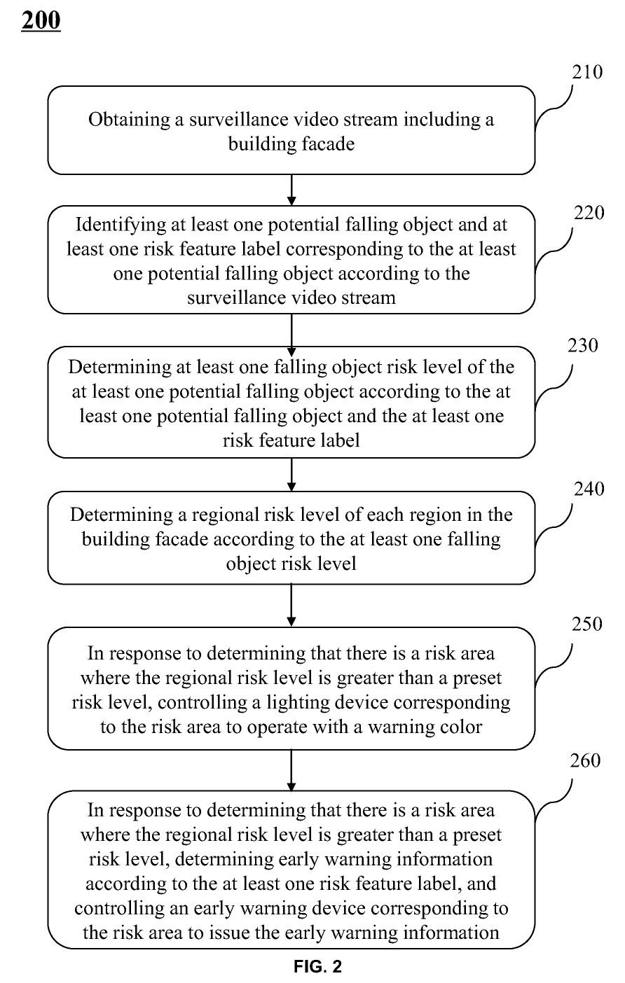

More descriptions may be found in FIGS. 2-4 and the related descriptions.

In some embodiments, each module may communicate with the data center to execute a data obtaining/processing task according to a corresponding instruction.

The data center 135 includes a database 1351, a model library 1352, and a computing unit 1353. The database 1351 stores data obtained by the falling object emergency supervision management platform 130 through interaction with other platforms and/or processing results or instructions generated by the falling object emergency supervision management platform 130 processing data. The model library 1352 stores various models required for executing the method for smart city falling object emergency supervision, e.g., a neural network model, a machine learning model, a large language model, etc. The computing unit 1353 executes data processing. The computing unit 1353 may invoke a corresponding data processing model from the model library 1352 and retrieve corresponding data to be processed from the database 1351.

In some embodiments, the falling object emergency supervision management platform 130 may perform data interaction with the falling object emergency supervision service platform 120 and/or the falling object emergency supervision sensing network platform 140 via the data center 135.

In some embodiments, the falling object emergency supervision management platform may further include a plurality of management sub-platforms. For example, the plurality of management sub-platforms include an emergency prevention sub-platform, an emergency monitoring sub-platform, a risk prevention sub-platform, and an emergency response sub-platform.

The emergency prevention sub-platform is configured to execute prevention work for a falling object event. For example, the emergency prevention sub-platform conveys hazards of the falling objects, preventive measures, etc., to a user.

The emergency monitoring sub-platform is configured to control a monitoring device (e.g., a surveillance device) to monitor an area where a falling object may occur.

The risk prevention sub-platform is configured to execute emergency prevention work when a falling object risk exists. For example, the risk prevention sub-platform controls the surveillance device to perform continuous, high-density monitoring, instructs a worker to remove a dangerous object, controls a lighting device or a user terminal in an area that may be endangered by the falling object to issue the early warning information, etc.

The emergency response sub-platform is configured to execute handling work for the falling object event when the falling object event occurs. For example, the emergency response sub-platform controls a falling object removal device to clean up the falling object, perform aftermath work, etc.

The falling object emergency supervision sensing network platform 140 is a sensing communication platform for uploading sensing information and transmitting control information. For example, the falling object emergency supervision sensing network platform 140 may be configured as a gateway, a data interface, etc. The falling object emergency supervision sensing network platform 140 may upload the surveillance video stream to the falling object emergency supervision object platform 150 and transmit an instruction related to falling object monitoring to the falling object emergency supervision object platform 150.

The falling object emergency supervision object platform 150 is a platform for information sensing and task execution. For example, the falling object emergency supervision object platform 150 may be configured as a monitoring device (including an unmanned aerial vehicle, a high-position fixed camera, other mobile carriers equipped with an image acquisition device (e.g., a vehicle), etc.) and a warning device (including a roadside lighting device, a speaker, etc.).

In some embodiments of the present disclosure, the IoT large model architecture provided by the system 100 enables efficient operation of a large amount of data. A closed loop of data obtaining, processing, and execution is formed among the various platforms, improving the efficiency and reliability of data processing. Various artificial intelligence models are integrated into the large model architecture, further facilitating data sensing and processing.

It should be noted that the above description of the system 100 is for convenience only and is not intended to limit the scope of the present disclosure to the cited embodiments. It can be understood that a person skilled in the art, upon understanding the principles of the system, may arbitrarily combine various platforms or constitute subsystems to connect to other platforms without departing from the principles.

FIG. 2 is a flowchart illustrating an exemplary process for smart city falling object emergency supervision according to some embodiments of the present disclosure. As shown in FIG. 2, the process 200 includes the following steps:

In 210, obtaining a surveillance video stream including a building facade.

The surveillance video stream refers to a video stream composed of an image sequence of the monitored building facade. For example, the surveillance video stream may include a video stream composed of an image sequence of the monitored building facade within a preset time period (e.g., 10 minutes, 30 minutes, 1 hour, etc.). The surveillance video stream has a high resolution, e.g., a resolution of 1080p, 4k, etc.

In some embodiments, the falling object emergency supervision management platform obtains the surveillance video stream via a monitoring device of the falling object emergency supervision object platform. An unmanned aerial vehicle may be equipped with a high-definition camera. A high-position fixed camera is installed on a lamppost or a building opposite the building.

In some embodiments, the surveillance video stream is video data obtained after further processing an initial video stream.

In some embodiments, the falling object emergency supervision management platform collects a surveillance video stream including the building facade, which may include: obtaining an initial video stream captured by a high-position fixed camera; determining a plurality of suspicious locations according to the initial video stream; generating a supplementary shooting instruction according to the plurality of suspicious locations, and obtaining a plurality of supplementary shooting video streams, wherein the supplementary shooting instruction is configured to control a plurality of supplementary shooting devices to perform image acquisition on the plurality of suspicious locations; and determining the surveillance video stream according to the plurality of supplementary shooting video streams and the initial video stream.

The initial video stream refers to a video stream obtained by directly shooting an entire monitoring range. For example, the initial video stream includes a video stream of the entire building facade directly obtained by a monitoring device. Compared with the surveillance video stream, the initial video stream may have a lower resolution and a lower recognition degree for a potential falling object.

In some embodiments, the falling object emergency supervision management platform continuously shoots the building facade through the high-position fixed camera to obtain the initial video stream.

A suspicious location refers to a position on the building facade where there may be a risk of an object falling. The suspicious location may be a position coordinate, a regional range, etc., of the building facade. For example, a position or a regional range of a wall crack, a hanging flowerpot, a shaking outdoor air conditioner unit, etc. A size of the regional range may be determined based on the size of a potential falling object.

In some embodiments, the falling object emergency supervision management platform may process the initial video stream through an image recognition algorithm to determine a plurality of suspicious locations. For example, using the image recognition algorithm, a position or a regional range in the initial video stream that is suspected to be a potential falling object is identified and marked. The position or the regional range corresponds to an actual position coordinate of the building facade used to determine the suspicious location. The image recognition algorithm may adopt a plurality of computer vision technologies, e.g., an object detection algorithm, an image segmentation algorithm, etc.

In some embodiments, the suspicious location may also be determined in other ways. For example, a trained machine learning model may be used to analyze the initial video stream, identify a position or a regional range of a specific texture, shape, or color, and determine the suspicious location.

In some embodiments of the present disclosure, by performing image recognition processing on the initial video stream obtained by the high-position fixed camera, a position where a potential falling object may be located is preliminarily determined. Based on this, the plurality of suspicious locations are determined. This achieves continuous monitoring of a large-scale region and early identification of potential risks, improves the targeting of monitoring for at least one potential falling object, and provides a basis for subsequent refined analysis and early warning.

In some embodiments, the falling object emergency supervision management platform generates a supplementary shooting instruction based on the plurality of suspicious locations and obtains a plurality of supplementary shooting video streams.

A supplementary shooting device is a device for performing image acquisition at the suspicious location. The supplementary shooting device may be all or part of the devices in the monitoring device.

The supplementary shooting video stream refers to a video stream obtained by supplementary shooting of the suspicious location.

In some embodiments, the falling object emergency supervision management platform determines a position for supplementary shooting, the supplementary shooting device, a supplementary shooting duration, and supplementary shooting parameters based on the position of the suspicious location, the position and the shooting angle of each supplementary shooting device, and integrates the supplementary shooting instruction.

For example, for the suspicious location at a position such as a blind spot on a main facade of a building, an area on a back facade of the building, a corner of an L-shaped building, an angle adjacent to a building, a roof or eave area, or above a narrow alley, which cannot be obtained by a fixed monitoring angle, a monitoring device capable of performing comprehensive and blind-spot-free acquisition may be determined for supplementary shooting based on characteristics such as the position and height of each suspicious location. Specific parameters such as the position for supplementary shooting, the supplementary shooting device, the supplementary shooting duration, and the supplementary shooting parameters may be adjusted and determined manually or by system control based on the position, height, angle, etc., of each suspicious location.

In some embodiments, after generating the supplementary shooting instruction, the falling object emergency supervision management platform controls the supplementary shooting devices to obtain the supplementary shooting video streams based on the supplementary shooting instruction.

In some embodiments, the supplementary shooting instruction may be generated, and the supplementary shooting video streams may be obtained in other ways. For example, the supplementary shooting devices may be manually operated to perform real-time supplementary shooting based on the suspicious location.

In some embodiments, the falling object emergency supervision management platform determines the surveillance video stream based on the supplementary shooting video streams and the initial video stream.

In some embodiments, the falling object emergency supervision management platform fuses the supplementary shooting video streams and the initial video stream as the surveillance video stream through image registration and fusion technology. Through fusion, wide-area monitoring information provided by the initial video stream and local high-precision detail information provided by the supplementary shooting video streams are registered and fused to obtain a more comprehensive and clearer surveillance video stream of the building facade.

In some embodiments of the present disclosure, through a collaborative mechanism of obtaining a wide-area initial video stream and then performing supplementary shooting for the suspicious location, a contradiction between fixed monitoring having blind spots and mobile inspection having low efficiency is solved. High-efficiency and high-precision data acquisition for suspicious hazards is achieved. A surveillance video stream, including higher-precision and more accurate falling object information, can be obtained.

In 220, identifying at least one potential falling object and at least one risk feature label corresponding to the at least one potential falling object according to the surveillance video stream.

The potential falling object is an object at a high altitude that may fall. For example, the potential falling object includes a decorative object (e.g., a decorative wall surface, a wall tile), a placed object (e.g., a flowerpot), or a wall-mounted object (e.g., an outdoor air conditioner unit) that may fall from the building facade.

The risk feature label refers to a label reflecting the attribute characteristics of the potential falling object. For example, the risk feature label includes a type, a material, a size/area, a swinging feature, a connection feature, and a risk type of the potential falling object.

The swinging feature includes a swinging part and a swinging amplitude of the potential falling object.

The connection feature refers to a connection manner between the potential falling object and the building facade, e.g., iron nail fixing, steel cable fixing, or welding.

The risk type refers to a type characterizing stability of the falling object, including an unstable falling object, a new falling object, and a surface falling object. The unstable falling object refers to an unstable (swaying) object. The new falling object refers to an object that appears at an unconventional location on the building facade within a short period of time (e.g., 10 minutes, 30 minutes). The surface falling object refers to a surface object of a building, such as a cracked coating or a decorative object.

In some embodiments, the falling object emergency supervision management platform processes the surveillance video stream through an image recognition engine to determine the potential falling object and the corresponding risk feature label. The image recognition engine is loaded with an image recognition algorithm.

For example, the falling object emergency supervision management platform processes the surveillance video stream and a plurality of preset standard falling object images through the image recognition engine to locate a potential falling object area having a similarity to a standard falling object image higher than a similarity threshold. The standard falling object images are preset manually and are associated with the at least one corresponding risk feature label. The falling object emergency supervision management platform may determine the risk feature label of the standard falling object image as the risk feature label of the potential falling object. Alternatively, the falling object emergency supervision management platform may further identify the potential falling object area in the surveillance video stream to determine the risk feature label.

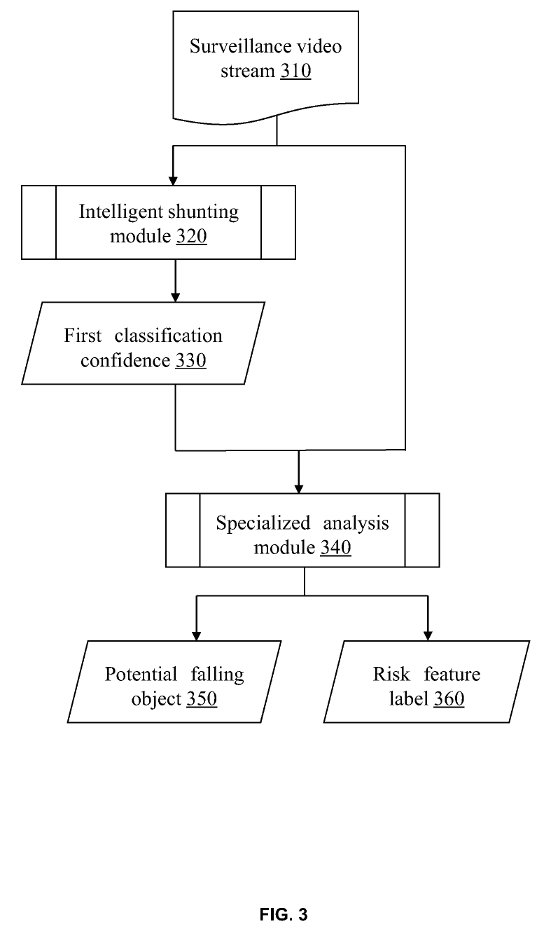

In some embodiments, the falling object emergency supervision management platform processes the surveillance video stream through a classification recognition model to determine a potential falling object and a corresponding risk feature label. More descriptions may be found in FIGS. 3-5 and related descriptions.

In 230, determining at least one falling object risk level of the at least one potential falling object according to the at least one potential falling object and the at least one risk feature label.

The falling object risk level is configured to measure a risk degree of the potential falling object falling. For example, the falling object risk level is divided into high, medium, and low levels, or first level, second level, and third level, according to the falling risk degree from high to low.

In some embodiments, the falling object emergency supervision management platform determines the falling object risk level by retrieving a vector database.

The vector database includes feature vectors and labels corresponding to the feature vectors. The feature vectors are constructed from a plurality of standard potential falling objects and standard risk feature labels corresponding to the plurality of standard potential falling objects. The label corresponding to a feature vector is a falling object risk level corresponding to a standard potential falling object and its standard risk feature label.

In some embodiments, the falling object emergency supervision management platform clusters a plurality of historical potential falling objects based on a type, a material, a connection feature, and a risk type in historical risk feature labels corresponding to the plurality of historical potential falling objects at a historical time. For each cluster after clustering, a union of the plurality of historical potential falling objects therein is used as a standard potential falling object. The falling object emergency supervision management platform determines a mean value of size/area and swinging feature in the historical risk feature labels corresponding to the plurality of historical potential falling objects, and a union of the type, the material, the connection feature, and the risk type, as a standard risk feature label corresponding to the standard potential falling object.

The falling object emergency supervision management platform performs embedding processing on the standard potential falling object and the standard risk feature label through an embedding layer to determine a feature vector.

In some embodiments, the falling object emergency supervision management platform obtains a falling ratio of a count of historical potential falling objects that fell within a preset time (e.g., one day, one week, etc.) after the historical time in a cluster corresponding to the feature vector to a total count of historical potential falling objects in the cluster. The falling object emergency supervision management platform obtains a loss caused by the historical potential falling objects that fell within the preset time after the historical time. The falling object emergency supervision management platform determines the falling object risk level corresponding to the feature vector through a preset table based on the falling ratio and the loss. The preset table stores a correspondence relationship between a plurality of falling ratios and losses, and the at least one falling object risk level.

In some embodiments, the falling object emergency supervision management platform determines a target vector based on the potential falling object and the risk feature label through the embedding layer, selects a feature vector with a highest similarity to the target vector from the vector database, and determines the falling object risk level corresponding to the feature vector as the falling object risk level of the potential falling object. Each potential falling object corresponds to a falling object risk level.

In some embodiments, the falling object risk level of the potential falling object may also be determined through other algorithms. For example, the determination may be based on an expert experience rule base.

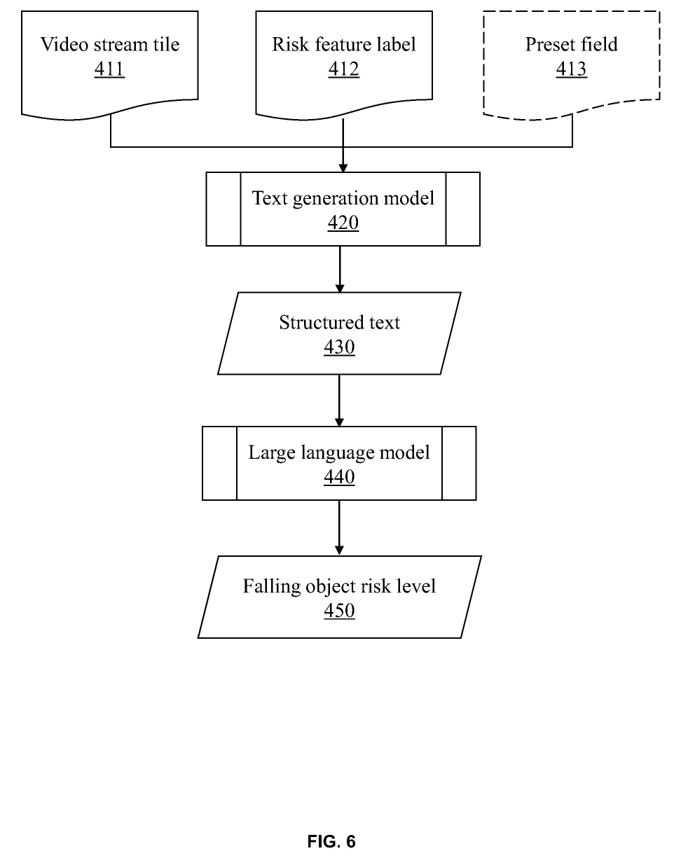

In some embodiments, more description of determining the falling object risk level through a text generation model and a large language model by the falling object emergency supervision management platform may be found in FIG. 6 and related descriptions.

In 240, determining a regional risk level of each region in the building facade according to the at least one falling object risk level.

The regional risk level refers to a risk degree of the potential falling object falling in each region of the building facade.

In some embodiments, the falling object emergency supervision management platform uniformly divides the building facade into a plurality of regions. The falling object emergency supervision management platform determines a highest falling object risk level among the at least one falling object risk level corresponding to the at least one potential falling object in each region as the regional risk level of each region.

In some embodiments, the regional risk level may also be determined through other algorithms. For example, a weight is determined according to a count of the at least one potential falling object in each region, and a weighted average falling object risk level of the plurality of regions is determined using the weight.

In some embodiments, the regional risk level of some building regions is greater than a preset risk level, and the regional risk level of some building regions is lower than the preset risk level.

In 250, in response to determining that there is a risk area where the regional risk level is greater than the preset risk level, controlling a lighting device corresponding to the risk area to operate with a warning color.

The preset risk level refers to a condition that a regional risk level needs to meet, which is set based on experience.

The risk area refers to an area of the building facade where the regional risk level is greater than the preset risk level.

The lighting device is a device used for road lighting, such as a street light.

The warning color refers to a preset light color for warning purposes. The warning color is determined by presetting or by a system default setting. For example, the warning color is red.

In some embodiments, the falling object emergency supervision management platform may send a warning instruction to the lighting device corresponding to the risk area to control the lighting device to illuminate in the warning color. The falling object emergency supervision management platform may also set the lighting device to flash at a preset frequency in the warning instruction.

In 260, in response to determining that there is a risk area where the regional risk level is greater than the preset risk level, determining an early warning information according to the at least one risk feature label, and controlling an early warning device corresponding to the risk area to issue the early warning information.

The early warning information refers to information used to indicate a possible falling object. For example, the early warning information may be "There is a risk of building surface detachment in the XX road section/position area, please detour!"

The early warning device refers to a device used to issue the early warning information. For example, the early warning device includes an LED display screen, an electronic warning sign, a sound system, or a loudspeaker around the building facade.

In some embodiments, the falling object emergency supervision management platform matches corresponding early warning information through an early warning preset table according to a risk type of the potential falling object in the risk area. The early warning preset table includes a plurality of potential falling objects with different risk types and the corresponding early warning information.

In some embodiments, the falling object emergency supervision management platform controls the early warning device corresponding to the risk area to issue the early warning information through a control instruction. The control instruction may include early warning information text, a warning time, and a warning form (e.g., text, voice).

In some embodiments, the early warning device further includes a vehicle-mounted terminal, and the falling object emergency supervision management platform can generate a detour route based on the early warning information; control an interaction screen of the vehicle-mounted terminal to display the detour route, and control a playback device of the vehicle-mounted terminal to broadcast the early warning information.

The detour route refers to a new travel route planned for a vehicle after a road section corresponding to the risk area is set as impassable.

In some embodiments, the falling object emergency supervision management platform sets a road corresponding to the risk area as impassable based on the early warning information, and generates the detour route based on a current location and a destination of the vehicle using a shortest path planning algorithm. The shortest path planning algorithm may be a Dijkstra algorithm or a Floyd algorithm.

In some embodiments, the detour route may also be generated in other ways. For example, the detour route may be dynamically adjusted and generated based on real-time traffic data and map information.

The vehicle-mounted terminal refers to a terminal device installed on a vehicle. The interaction screen refers to a screen for displaying information and enabling interaction. The playback device refers to a vehicle audio device.

In some embodiments, the falling object emergency supervision management platform sends the detour route to the vehicle-mounted terminal and controls the interaction screen to display the detour route.

In some embodiments, the falling object emergency supervision management platform sends the early warning information to the vehicle-mounted terminal and controls the playback device to broadcast the early warning information. For example, the early warning information is broadcast to personnel in the vehicle in a voice form.

In some embodiments of the present disclosure, the detour route is automatically generated for the vehicle-mounted terminal based on the early warning information, and the vehicle-mounted terminal is controlled to display the detour route and broadcast the early warning information. This achieves precise and dynamic traffic guidance based on the risk area, effectively improves the efficiency and accuracy of the emergency response to the falling objects, and ensures the safety of surrounding traffic participants.

In some embodiments of the present disclosure, the falling object risk level of the potential falling object and a regional risk level of each region of the building facade are determined by obtaining a surveillance video stream including the building facade. When the risk area exists, a street light can be controlled to operate in the warning color in a timely manner, and early warning information is determined based on the risk feature label and issued by a warning device. This effectively provides early warning and management for falling object risks, reduces the risk of potential falling object falling, and ensures pedestrian safety and property protection.

FIG. 3 is a schematic diagram of an exemplary process for determining a potential falling object and a risk feature label based on a model according to some embodiments of the present disclosure.

In some embodiments, the falling object emergency supervision management platform may identify the at least one potential falling object and the at least one risk feature label according to the surveillance video stream using a classification recognition model.

The classification recognition model includes a machine learning model, such as a trained Graph Neural Network (GNN) model, Convolutional Neural Network (CNN) model, Long Short-Term Memory (LSTM) model, etc.

More descriptions regarding the surveillance video stream, the potential falling object, and the risk feature label may be found in FIG. 2 and related descriptions.

In some embodiments, the classification recognition model may be trained using the first training samples and the first labels.

The first training samples include a plurality of sample surveillance video streams. The first labels include a sample potential falling object corresponding to a sample surveillance video stream and a sample risk feature label corresponding to the sample potential falling object.

In some embodiments, the first training samples may be obtained by monitoring any building facade using a monitoring device, and the first labels may be obtained based on manual annotation. Processes for training the classification recognition model include, but are not limited to, a gradient descent method, etc.

In some embodiments of the present disclosure, by introducing the classification recognition model and utilizing the powerful data processing capability of the model, automated and intelligent identification of the at least one potential falling object and the at least one risk feature label in the surveillance video stream is achieved. This significantly improves the accuracy and efficiency of identification, providing a reliable data foundation for subsequent falling object risk assessment and emergency response.

In some embodiments, as shown in FIG. 3, the classification recognition model includes an intelligent shunting module 320 and a specialized analysis module 340. The falling object emergency supervision management platform may identify at least one potential falling object and at least one corresponding risk feature label based on the surveillance video stream using the classification recognition model, including: determining a first classification confidence 330 of the surveillance video stream for each region of the building facade using the intelligent shunting module 320; and identifying the at least one potential falling object 350 and the at least one risk feature label 360 based on the surveillance video stream 310 and the first classification confidence 330 using the specialized analysis module 340.

The first classification confidence refers to a classification reliability degree of a potential falling object in a region of the building facade. The first classification confidence includes a dynamic confidence, a change confidence, and a surface anomaly confidence, which may be represented by a value less than or equal to 1.

The dynamic confidence refers to a confidence that an unstable falling object exists in the region. The change confidence refers to a confidence that a new falling object exists in each region. The surface anomaly confidence refers to a confidence that a surface falling object exists in the region.

The intelligent shunting module is a processing module in the classification recognition model configured to determine the first classification confidence of the surveillance video stream of each region.

The specialized analysis module is a processing module in the classification recognition model configured to identify the potential falling object and the corresponding risk feature label.

In some embodiments, the intelligent shunting module or the specialized analysis module may be a structural layer in the classification recognition model or an independent trained machine learning model. For example, the intelligent shunting module may be a Convolutional Neural Network (CNN) model, a Long Short-Term Memory (LSTM) model, etc.

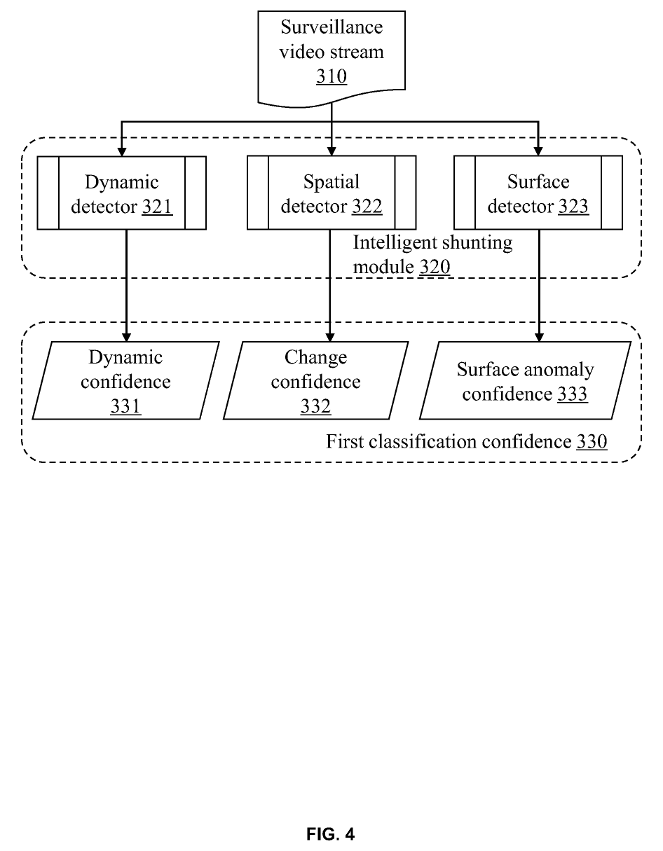

FIG. 4 is a schematic diagram of an exemplary process for determining a first classification confidence according to some embodiments of the present disclosure.

In some embodiments, as shown in FIG. 4, the intelligent shunting module 320 includes a dynamic detector 321, a spatial detector 322, and a surface detector 323.

The dynamic detector 321 may be an algorithm module integrating an optical flow algorithm.

In some embodiments, an input of the dynamic detector 321 includes the surveillance video stream 310, and an output includes a dynamic confidence 331 of each region.

In some embodiments, the dynamic detector uses the optical flow algorithm to analyze a motion magnitude, motion consistency, and duration of pixel points in the surveillance video stream, performs a weighted summation on the motion magnitude, motion consistency, and duration of the pixel points, and determines the dynamic confidence of each region.

The motion magnitude is a mean of optical flow velocities of a plurality of pixel points in the surveillance video stream at a plurality of moments (e.g., each second within 60 seconds) in each region, where the plurality of moments are determined based on a duration of the surveillance video stream. The motion consistency is a consistency of motion direction and optical flow velocity of the pixel points in the surveillance video stream of each region. The duration of pixel points is a mean of motion durations of the pixel points in the surveillance video stream of each region.

In some embodiments, the dynamic detector first performs normalization processing on the motion magnitude, motion consistency, and duration of the pixel points, and then performs the weighted summation. The normalization processing may adopt Min-Max normalization, and weight coefficients for the weighted summation may be set based on experience or by default by the system.

The spatial detector 322 integrates a Siamese Network.

In some embodiments, an input of the spatial detector 322 is the surveillance video stream 310, and an output is a change confidence 332 of each region.

In some embodiments, the Siamese Network includes two branch networks, which may be one of a Residual Network (ResNet), an EfficientNet, a Visual Geometry Group (VGG) network, etc. The two branch networks process a previous frame surveillance image and a current frame surveillance image in the surveillance video stream, respectively, to obtain two image feature vectors.

The spatial detector further determines the change confidence based on the two image feature vectors. For example, the spatial detector determines a similarity between the two image feature vectors. The similarity may be determined based on a vector distance (e.g., Euclidean distance, cosine distance, etc.). The spatial detector subtracts the similarity from 1 to obtain the change confidence. A higher similarity corresponds to a lower confidence.

In some embodiments, the Siamese Network may be obtained through training. The training process includes: obtaining two pre-trained branch networks, where the two pre-trained branch networks share weights; and performing incremental training on the two pre-trained branch networks based on an incremental training set to fine-tune the pre-trained networks.

The incremental training set includes positive sample pairs and negative sample pairs. A positive sample pair is images of a same building facade region captured at different times without changes, with a label of 1. A negative sample pair is images of the same building facade region captured at different times with significant changes, with a label of 0.

The surface detector 323 integrates an unsupervised anomaly detection model, e.g., PatchCore. PatchCore extracts image features through a pre-trained network (e.g., WideResNet50) and constructs a memory bank that includes feature vectors of normal samples. An anomaly score for a test image is determined based on a distance between the test image and the feature vectors in the memory bank. A smaller distance indicates a higher degree of normality.

In some embodiments, an input of the surface detector 323 is the surveillance video stream 310, and an output is a surface anomaly confidence 333 for each region.

In some embodiments, for an image tile in the surveillance video stream of each region, the surface detector determines the anomaly score of the image tile relative to a standard image tile of a memory bank of feature vectors of normal samples of PatchCore. The surface anomaly confidence is determined based on the anomaly score. A higher anomaly score indicates that the image tile deviates further from a normal state, and the surface anomaly confidence is higher. The standard image tile is an image of a position of a building facade corresponding to a normal state.

In some embodiments, PatchCore is obtained through training. The training process includes: inputting a historical image set of building facades without anomalies (i.e., a standard image set) into a feature extractor (i.e., the pre-trained network), and storing extracted feature vectors into a PatchCore memory bank as the standard image tiles.

In some embodiments, the first classification confidence may also be determined in other ways. For example, a trained machine learning model may be used to process the surveillance video stream to obtain the first classification confidence for each region.

In some embodiments, the falling object emergency supervision management platform identifies the at least one potential falling object and the at least one risk feature label according to the surveillance video stream and the first classification confidence using the specialized analysis module.

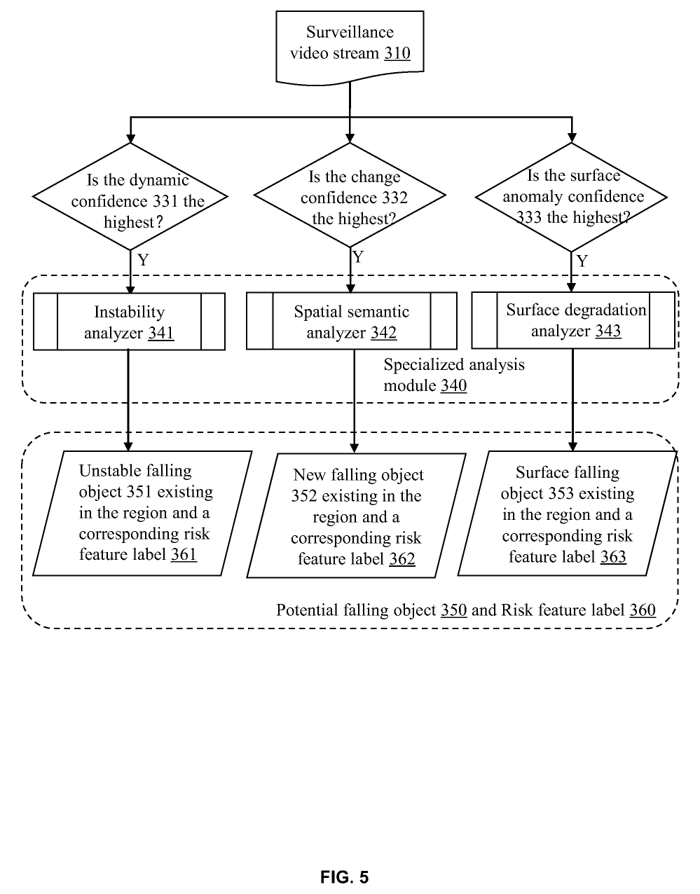

FIG. 5 is a schematic diagram of an exemplary process for determining a potential falling object and a risk feature label according to some embodiments of the present disclosure.

In some embodiments, as shown in FIG. 5, the specialized analysis module 340 includes an instability analyzer 341, a spatial semantic analyzer 342, and a surface degradation analyzer 343.

In some embodiments, the specialized analysis module 340 determines, based on the first classification confidence 330, which analyzer to use to process the surveillance video stream of each region. For example, the specialized analysis module 340 determines which is the highest among the first classification confidence 330 for each region: the dynamic confidence 331, the change confidence 332, or the surface anomaly confidence 333? Then, based on this determination, the instability analyzer 341, the spatial semantic analyzer 342, and the surface degradation analyzer 343 are respectively configured to process the surveillance video streams of regions where the dynamic confidence 331 is the highest, the change confidence 332 is the highest, and the surface anomaly confidence 333 is the highest.

For example, if a dynamic confidence of a region is higher than the other two confidences, the instability analyzer is determined to process the corresponding surveillance video stream.

The instability analyzer 341 integrates an LSTM model.

In some embodiments of the present disclosure, an input of the instability analyzer 341 includes the surveillance video stream 310 of a region with a high dynamic confidence 331. An output includes an unstable falling object 351 existing in the region and a corresponding risk feature label 361.

In some embodiments of the present disclosure, the instability analyzer is obtained through training based on first analysis samples and first analysis labels. The first analysis samples are historical surveillance video streams of a plurality of building facades at a plurality of historical moments. The first analysis labels are the unstable falling object and the corresponding risk feature label corresponding to the first analysis samples.

The first analysis labels are constructed using an object that actually fell within a subsequent preset period of the historical surveillance video stream as the unstable falling object, and identifying its swinging feature, material, size/area, connection method, etc., before the fall through an image recognition algorithm to determine the risk feature label.

The spatial semantic analyzer 342 is implemented by integrating an image differencing algorithm and a Contrastive Language-Image Pre-training (CLIP) model.

In some embodiments, an input of the spatial semantic analyzer 342 includes the surveillance video stream 310 of a region with a high change confidence 332. An output includes a new falling object 352 existing in the region and a corresponding risk feature label 362.

The image differencing algorithm performs pixel-level subtraction between two consecutive frames of images in the surveillance video stream 310. A non-black region in the subtraction result (i.e., a region with a visual change) is determined as one or more change regions. Then, the one or more change regions are input into the CLIP model to obtain the new falling object corresponding to the one or more change regions.

In some embodiments, the spatial semantic analyzer is obtained through training. The training process includes: performing incremental training on a pre-trained general CLIP model using second analysis samples and second analysis labels to optimize and adjust parameters of the pre-trained general CLIP model.

The second analysis samples are one or more historical change regions in historical surveillance video streams of a plurality of building facades at a plurality of historical moments. The second analysis labels are the new falling object and the corresponding risk feature label corresponding to the one or more historical change regions.

A construction process of the second analysis labels is similar to that of the first analysis labels and is not repeated here.

The surface degradation analyzer 343 is implemented by integrating a Convolutional Neural Network (CNN). An input of the surface degradation analyzer is the surveillance video stream 310 of a region with a high surface anomaly confidence 333. An output includes a surface falling object 353 existing in the region and a corresponding risk feature label 363.

In some embodiments of the present disclosure, the surface degradation analyzer is obtained through training based on third analysis samples and third analysis labels. The third analysis samples are historical surveillance video streams of a plurality of building facades at a plurality of historical moments. The third analysis labels are the surface falling object and the corresponding risk feature label corresponding to the third analysis samples at the historical moments.

A construction process of the third analysis labels is similar to that of the first analysis labels and is not repeated here.

In some embodiments of the present disclosure, a general potential falling object identification task is decomposed into sub-problems such as unstable falling object, new falling object, and surface anomaly. An intelligent shunting module is used to determine the first classification confidence. Then, based on the first classification confidence, a corresponding analyzer in the specialized analysis module is determined to process the surveillance video stream of different risk types. This method improves the pertinence and accuracy of data processing, thereby improving the accuracy and reliability of identifying the potential falling object and its risk feature label.

FIG. 6 is a schematic diagram of an exemplary process for determining a falling object risk level based on a model according to some embodiments of the present disclosure.

In some embodiments, as shown in FIG. 6, the falling object emergency supervision management platform determines at least one falling object risk level of at least one potential falling object based on the at least one potential falling object and at least one risk feature label, including: determining at least one structured text 430 of the at least one potential falling object according to at least one video stream tile 411 and the at least one risk feature label 412 using a text generation model 420; and inputting the at least one structured text 430 into a large language model 440 to determine the at least one falling object risk level 450.

The video stream tile refers to a local image region in the surveillance video stream corresponding to the potential falling object. The risk feature label corresponds to the potential falling object.

In some embodiments, the falling object emergency supervision management platform may segment a potential falling object region in each frame of images in the surveillance video stream through an image segmentation algorithm to obtain the video stream tile.

The structured text refers to text describing the potential falling object and its risk features, having a preset format and text. For example, the structured text includes standardized text with information such as region number, location, potential falling object type, material feature, size, swinging feature, connection feature, the risk type, shooting time, and comparison information with a previous shooting.

In some embodiments, the structured text further includes a second classification confidence corresponding to the potential falling object.

The second classification confidence refers to a classification reliability degree of the potential falling object in the video stream tile.

In some embodiments, the structured text may add a preset paragraph to reflect the second classification confidence corresponding to the potential falling object. For example, when a text generation model generates the structured text of the potential falling object, the second classification confidence may be added as additional information to a preset paragraph of the structured text.

In some embodiments, the second classification confidence may be determined by processing the video stream tile through the intelligent shunting module. More descriptions may be found in FIG. 3 and FIG. 4 and related descriptions.

In some embodiments, the second classification confidence may also be determined by: determining a first classification confidence of the surveillance video stream of each region according to the surveillance video stream using an intelligent shunting module to obtain first classification confidences of regions; and determining the at least one second classification confidence based on the first classification confidences.

More descriptions of determining the first classification confidence through the intelligent shunting module may be found in FIG. 3 and FIG. 4 and related descriptions.

In some embodiments, the falling object emergency supervision management platform determines the second classification confidence based on a type of the potential falling object in the region and the first classification confidence of the region corresponding to the video stream tile.

For example, in response to a determination that a type of the potential falling object in the region is only an unstable falling object, the second classification confidence is determined as a dynamic confidence.

As another example, in response to a determination that the type of the potential falling object in the region includes a plurality of types, a highest first classification confidence corresponding to the plurality of potential falling objects is determined as the second classification confidence. Alternatively, the different first classification confidences are weighted and summed to determine the second classification confidence. A weight for the weighted sum is positively correlated with a quantity and a degree of harm of each type of the potential falling object. The degree of harm may be determined based on an area and a weight of the potential falling object.

In some embodiments of the present disclosure, the first classification confidence of each region is determined through the intelligent shunting module. On this basis, the second classification confidence of the potential falling object is determined, which improves the accuracy of determination of the second classification confidence and provides a more detailed and accurate basis for subsequent generation of structured text and judgment of the falling object risk level.

In some embodiments of the present disclosure, the second classification confidence is added to the structured text. This provides more reliable judgment information for a large language model, enabling the large language model to make a more accurate judgment of the falling object risk level.

More descriptions of the surveillance video stream, the potential falling object, the risk feature label, and the falling object risk level may be found in FIG. 2 and related descriptions.

The text generation model may be a neural network model or a trained machine learning model. For example, the text generation model may be an LSTM.

The text generation model may be obtained by training with second training samples and second labels. The second training samples include a plurality of historical video stream tiles corresponding to a plurality of historical potential falling objects and historical risk feature labels. The second label is a structured text corresponding to the historical potential falling object of the second training sample.

In some embodiments, a process for determining the second label is as follows. Text information is output by identifying the historical video stream tile through a plurality of algorithms (e.g., the image recognition algorithm, etc.). The text information is combined with the corresponding historical risk feature label and input into the large language model. Structured text with the highest accuracy of a falling object risk level predicted by the large language model is used as the second label.

In some embodiments, at least one structured text corresponding to at least one potential falling object with a same risk type has the same format. An input of the text generation model 420 further includes at least one preset field 413 corresponding to the at least one potential falling object. In some embodiments, the falling object emergency supervision management platform determines the at least one preset field 413 corresponding to the at least one potential falling object according to the at least one risk type of the at least one potential falling object.

The preset field refers to a format of the structured text corresponding to the potential falling object of different risk types. For example, the preset field may be a standard template or a standard format of the structured text, including a title of the structured text, a count of paragraphs, main information corresponding to each paragraph, etc.

In some embodiments, the preset field may be determined through a field preset table. The field preset table stores preset fields of structured texts corresponding to potential falling objects of different risk types.

In some embodiments, the field preset table may be obtained through cluster analysis. Objects of the cluster analysis are a plurality of cluster vectors determined based on a plurality of historical potential falling objects, historical risk types of the plurality of historical potential falling objects, and corresponding historical structured texts used.

In some embodiments, the falling object emergency supervision management platform performs clustering on the cluster vectors based on the risk type and the format of the structured text to obtain a plurality of clusters. Each cluster represents that the risk type and the format of the structured text are the same. For each risk type, there may be a plurality of different formats of structured text. Therefore, the risk type may correspond to a plurality of clusters.

The falling object emergency supervision management platform inputs structured texts in the plurality of clusters into the large language model to determine which cluster corresponds to a structured text with the most accurate prediction result. Then, the format of the structured text corresponding to the cluster is determined as a preset field associated with the risk type corresponding to the cluster.

In some embodiments, the preset field may also be determined in a variety of other ways. For example, the risk type and the format of structured text may be directly mapped by an expert system based on a preset rule base.

In some embodiments of the present disclosure, by determining different formats for the structured texts of the potential falling objects of different risk types, it is ensured that the structured texts of the potential falling objects of the same risk type have a unified format. This improves efficiency and consistency of the text generation model and provides standardized input for the large language model, evaluating the falling object risk level more accurately and reliably.

In some embodiments, the structured text 430 is input into the large language model 440 to determine the falling object risk level 450.

The large language model refers to a machine learning model with a natural language processing function. For example, the large language model may be a large language model (LLM), a GPT series model, a BERT series model, etc.

In some embodiments, the large language model is provided with a text description of task processing requirements. When the structured text is input into the large language model, the large language model automatically processes the structured text according to the task processing requirements and predicts the falling object risk level.

An exemplary task processing requirement is as follows: please determine a falling risk level (high/medium/low) of the corresponding potential falling object based on input the structured text, and briefly state judgment reasons and recommended emergency measures.

Merely by way of example, the structured text input into the large language model may include "Region Number: #A102; Location: outer edge of a south-facing windowsill on the 4th floor; Object Type: small cable reel; Reel housing is plastic, with cracks on the housing; The reel is fixed to a metal hook below the windowsill by a single thin steel cable; The end of the steel cable exhibits slight swaying of about 5 cm; No additional support around; Shooting Time: 2025-07-10 14:32; Comparison with previous shooting (2025-07-03): No hanging objects were seen at this location in the previous shooting." After receiving this piece of structured text, the large language model may output "Risk Level: High. Reasons: The plastic housing already has cracks, and it is suspended only by a single thin steel cable, which can already produce swaying in a light breeze. This fixing process lacks support. Once the steel cable connection point fatigues or the plastic housing shatters, falling is highly likely to occur. Recommendation: Immediately arrange for on-site manual reinforcement or removal of the reel, and check the integrity of the hook and the steel cable connector."

In some embodiments of the present disclosure, by using the text generation model and the large language model to process and determine the falling object risk level based on the video stream tile and the risk feature label, intelligent and automated assessment of potential falling object risk is achieved. This way converts visual information into machine-understandable text information and utilizes powerful semantic understanding capabilities of the large language model to perform in-depth analysis and judgment on complex risk features of the at least one potential falling object. This improves the accuracy and efficiency of falling object risk assessment and provides a more precise decision-making basis for emergency management of falling objects.

Embodiments of the present disclosure further provide a non-transitory computer-readable storage medium. When a computer reads computer instructions in the storage medium, the computer executes the method for smart city falling object emergency supervision according to any one of the above embodiments.

Basic concepts have been described above. Obviously, for a person skilled in the art, the above detailed disclosure is merely an example and does not constitute a limitation on the present disclosure. Although not explicitly stated herein, a person skilled in the art may make various modifications, improvements, and amendments to the present disclosure. Such modifications, improvements, and amendments are suggested in the present disclosure. Therefore, such modifications, improvements, and amendments still fall within the spirit and scope of the exemplary embodiments of the present disclosure.

Meanwhile, the present disclosure uses specific words to describe embodiments of the present disclosure. For example, terms such as "an embodiment," "one embodiment," and/or "some embodiments" mean a certain feature, structure, or characteristic related to at least one embodiment of the present disclosure. Therefore, it should be emphasized and noted that "an embodiment" or "one embodiment" or "an alternative embodiment" mentioned two or more times in different locations in the present disclosure does not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers and letters, or the use of other names described in the present disclosure is not intended to limit the order of processes and methods of the present disclosure. Although the foregoing disclosure discusses some inventive embodiments currently considered useful through various examples, it should be understood that such details are for illustrative purposes only. The appended claims are not limited to the disclosed embodiments. On the contrary, the claims are intended to cover all modifications and equivalent combinations that conform to the essence and scope of the embodiments of the present disclosure. For example, although the implementation of various components described above may be embodied in a hardware device, it may also be implemented as a software only solution, e.g., an installation on an existing server or mobile device.

Similarly, it should be noted that, in order to simplify the description of the present disclosure and thereby facilitate an understanding of one or more embodiments of the invention, various features are sometimes grouped into a single embodiment, figure, or description thereof in the foregoing description of the embodiments of the present disclosure. However, this method of disclosure does not imply that the object of the present disclosure requires more features than those recited in the claims. Rather, claimed subject matter may lie in less than all features of a single foregoing disclosed embodiment.

In some embodiments of the present disclosure, numbers describing quantities of ingredients or properties are used. It should be understood that such numbers used in describing the embodiments are, in some examples, modified by the terms "about," "approximately," or "substantially." Unless otherwise stated, "about," "approximately," or "substantially" indicates that the stated number allows a variation of ±20%. Accordingly, in some embodiments of the present disclosure, the numerical parameters set forth in the present disclosure and claims are approximations that may vary depending upon the desired properties of the individual embodiments. In some embodiments of the present disclosure, the numerical parameters should be considered in light of the number of reported significant digits and by applying ordinary rounding techniques. Although the numerical ranges and parameters setting forth the broad scope of some embodiments of the present disclosure are approximations, the numerical values set forth in the specific examples are reported as precisely as possible within the feasible range.

Each patent, patent application, patent application publication, and other material, such as articles, books, specifications, publications, documents, etc., cited herein is hereby incorporated by reference in its entirety. This incorporation excludes any application history documents that are inconsistent with or conflict with the content of the present disclosure, and also excludes any documents that limit the broadest scope of the claims of the present disclosure (whether currently or subsequently appended to the present disclosure). It should be noted that, if the description, definition, and/or use of terms in any incorporated material is inconsistent or conflicts with the description, definition, and/or use of terms in the present disclosure, the description, definition, and/or use of terms in the present disclosure shall prevail.

Finally, it should be understood that the embodiments described herein are merely illustrative of the principles of the embodiments of the present disclosure. Other variations may also fall within the scope of the present disclosure. Accordingly, by way of example and not limitation, alternative configurations of the embodiments of the present disclosure may be considered consistent with the teachings of the present disclosure. Accordingly, the embodiments of the present disclosure are not limited to those explicitly described and illustrated herein.

What is claimed is:

1. A method for smart city falling object emergency supervision, wherein the method is performed by a falling object emergency supervision management platform of an Internet of Things (IoT) large model system for smart city falling object emergency supervision, and comprises:
obtaining a surveillance video stream including a building facade;
identifying at least one potential falling object and at least one risk feature label corresponding to the at least one potential falling object according to the surveillance video stream;
determining at least one falling object risk level of the at least one potential falling object according to the at least one potential falling object and the at least one risk feature label;
determining a regional risk level of each region in the building facade according to the at least one falling object risk level;
in response to determining that there is a risk area where the regional risk level is greater than a preset risk level,
controlling a lighting device corresponding to the risk area to operate with a warning color; and
determining early warning information according to the at least one risk feature label, and controlling an early warning device corresponding to the risk area to issue the early warning information.

2. The method according to claim 1, wherein the obtaining the surveillance video stream including the building facade includes:
obtaining an initial video stream captured by a high-position fixed camera;
determining a plurality of suspicious locations according to the initial video stream;
generating a supplementary shooting instruction according to the plurality of suspicious locations, and obtaining a plurality of supplementary shooting video streams, wherein the supplementary shooting instruction is configured to control a plurality of supplementary shooting devices to perform image acquisition on the plurality of suspicious locations; and
determining the surveillance video stream according to the plurality of supplementary shooting video streams and the initial video stream.

3. The method according to claim 1, wherein the early warning device further includes a vehicle-mounted terminal, and the method further comprises:
generating a detour route according to the early warning information; and
controlling an interaction screen of the vehicle-mounted terminal to display the detour route, and controlling a playback device of the vehicle-mounted terminal to broadcast the early warning information.

4. The method according to claim 1, wherein the identifying the at least one potential falling object and the at least one risk feature label corresponding to the at least one potential falling object according to the surveillance video stream includes:
identifying the at least one potential falling object and the at least one risk feature label according to the surveillance video stream using a classification recognition model, wherein the classification recognition model includes a machine learning model.

5. The method according to claim 4, wherein the classification recognition model includes an intelligent shunting module and a specialized analysis module, and the identifying the at least one potential falling object and the at least one risk feature label corresponding to the at least one potential falling object according to the surveillance video stream using the classification recognition model includes:
determining a first classification confidence of the surveillance video stream of the each region according to the surveillance video stream using the intelligent shunting module; and
identifying the at least one potential falling object and the at least one risk feature label according to the surveillance video stream and the first classification confidence using the specialized analysis module.

6. The method according to claim 5, wherein the plurality of suspicious locations is determined by:
processing an initial video stream captured by a high-position fixed camera using an image recognition algorithm to determine locations of the at least one potential falling object; and
determining the plurality of suspicious locations based on the at least one location of the at least one potential falling object.

7. The method according to claim 1, wherein the determining the at least one falling object risk level of the at least one potential falling object according to the at least one potential falling object and the at least one risk feature label includes:
determining at least one structured text of the at least one potential falling object according to at least one video stream tile corresponding to the at least one potential falling object and the at least one risk feature label using a text generation model; and
inputting the at least one structured text into a large language model to determine the at least one falling object risk level.

8. The method according to claim 7, wherein the at least one structured text further includes at least one second classification confidence corresponding to the at least one potential falling object.

9. The method according to claim 8, wherein the at least one second classification confidence are determined by:
determining a first classification confidence of the surveillance video stream of the each region according to the surveillance video stream using an intelligent shunting module to obtain first classification confidences of regions; and
determining the at least one second classification confidence based on the first classification confidences.

10. The method according to claim 7, wherein the at least one structured text corresponding to the at least one potential falling object that has a same risk type has a same format, an input of the text generation model further includes at least one preset field corresponding to the at least one potential falling object, and the method further includes:
determining the at least one preset field corresponding to the at least one potential falling object according to at least one risk type of the at least one potential falling object.

11. An Internet of Things (IoT) large model system for smart city falling object emergency supervision, comprising a falling object emergency supervision management platform, wherein the falling object emergency supervision management platform includes:
an obtaining module, configured to obtain, through a falling object emergency supervision sensing network platform, a surveillance video stream including a building facade obtained by a falling object emergency supervision object platform;
a recognition module, configured to identify at least one potential falling object and at least one risk feature label corresponding to the at least one potential falling object according to the surveillance video stream;
a risk level determination module, configured to determine at least one falling object risk level of the at least one potential falling object according to the at least one potential falling object and the at least one risk feature label;
a warning module, configured to:
determine a regional risk level of each region in the building facade according to the at least one falling object risk level;
in response to determining that there is a risk area where the regional risk level is greater than a preset risk level,
send an instruction to the falling object emergency supervision object platform through the falling object emergency supervision sensing network platform to control a lighting device corresponding to the risk area to operate with a warning color; and
determine early warning information according to the at least one risk feature label, send the early warning information to a falling object emergency supervision user platform through a falling object emergency supervision service platform, and/or send the early warning information to the falling object emergency supervision object platform through the falling object emergency supervision sensing network platform to control an early warning device corresponding to the risk area to issue the early warning information.

12. The IoT large model system for smart city falling object emergency supervision according to claim 11, wherein the falling object emergency supervision management platform is further configured to:
obtain an initial video stream captured by a high-position fixed camera;
determine a plurality of suspicious locations according to the initial video stream;
generate a supplementary shooting instruction according to the plurality of suspicious locations, and obtain a plurality of supplementary shooting video streams; wherein the supplementary shooting instruction is configured to control a plurality of supplementary shooting devices to perform image acquisition on the plurality of suspicious locations; and
determine the surveillance video stream according to the plurality of supplementary shooting video streams and the initial video stream.

13. The IoT large model system for smart city falling object emergency supervision according to claim 11, wherein the early warning device further includes a vehicle-mounted terminal, and the falling object emergency supervision management platform is further configured to:
generate a detour route according to the early warning information; and
control an interaction screen of the vehicle-mounted terminal to display the detour route, and control a playback device of the vehicle-mounted terminal to broadcast the early warning information.

14. The IoT large model system for smart city falling object emergency supervision according to claim 11, wherein the falling object emergency supervision management platform is further configured to:
identify the at least one potential falling object and the at least one risk feature label according to the surveillance video stream using a classification recognition model, wherein the classification recognition model includes a machine learning model.

15. The IoT large model system for smart city falling object emergency supervision according to claim 14, wherein the classification recognition model includes an intelligent shunting module and a specialized analysis module; and the falling object emergency supervision management platform is further configured to:
determine a first classification confidence of the surveillance video stream of the each region according to the surveillance video stream using the intelligent shunting module; and
identify the at least one potential falling object and the at least one risk feature label according to the surveillance video stream and the first classification confidence using the specialized analysis module.

16. The IoT large model system for smart city falling object emergency supervision according to claim 15, wherein the falling object emergency supervision management platform is further configured to:
process an initial video stream captured by a high-position fixed camera using an image recognition algorithm to determine at least one location of the at least one potential falling object; and
determine the plurality of suspicious locations based on the at least one location of the at least one potential falling object.

17. The IoT large model system for smart city falling object emergency supervision according to claim 1, wherein the falling object emergency supervision management platform is further configured to:
determine at least one structured text of the at least one potential falling object according to at least one video stream tile corresponding to the at least one potential falling object and the at least one risk feature label using a text generation model; and
input the at least one structured text into a large language model to determine the at least one falling object risk level.

18. The IoT large model system for smart city falling object emergency supervision according to claim 17, wherein the at least one structured text further includes at least one second classification confidence corresponding to the at least one potential falling object.

19. The IoT large model system for smart city falling object emergency supervision according to claim 17, wherein the at least one structured text corresponding to the at least one potential falling object that has a same risk type has a same format; an input of the text generation model further includes at least one preset field corresponding to the at least one potential falling object; and the falling object emergency supervision management platform is further configured to:
determine the at least one preset field corresponding to the at least one potential falling object according to at least one risk type of the at least one potential falling object.

20. A non-transitory computer-readable storage medium storing computer instructions, wherein when a computer reads the computer instructions from the storage medium, the computer performs the method for smart city falling object emergency supervision according to claim 1.
